(19) United States
(12) Patent Application Publication
(10) Pub. No.: US 2003/0029578 A1
(43) Pub. Date: Feb. 13, 2003

(54) Modularized horizontal blind set

(76) Inventor: Han-Sen Lee, Chang-Hwa Hsien (TW)

Correspondence Address: Curtis L. Harrington, Suite 250, 6300 State University Drive, Long Beach, CA, 90815, US

(21) Appl. No.: 09/903,315

(22) Filed: Jul. 10, 2001

(51) Int. Cl. E06B 9/26

(52) U.S. Cl. 160/176.1 R

(57) ABSTRACT

A modularized horizontal blind set provides a configuration which is easily modifiable, reduces inventory costs and waste. The only ultimate waste created from the modularized horizontal blind set is the trimming of ladder and elevation string or cord during assembly of a cord and louver assembly to a channel and component assembly. A cord and louver assembly, includes a base slat, a series of slats inserted into a ladder cord, and a set of elevation cords strung through the slats, with the ladder cord and elevation cords preferably properly tied off to enable a rapid layout and interconnect with a selected channel member. In forming a custom sized assembly, workers can utilize a chart based upon the vertical height of the top channel, and the spacing of the ladder chord.

### FIELD OF THE INVENTION

The present invention relates to the field of window treatments, and more particularly to horizontal blind sets available as a modularized which facilitates rapid customizable assembly of the horizontal blind set in a manner particularly useful for professional installers.

### BACKGROUND OF THE INVENTION

Conventional Venetian or horizontal blind sets typically have an upper channel assembly for supporting a set of louver angular adjustment drums and for providing an upper fulcrum for the downward pulling of the bottom louver elevation cords in order that the bottom louver rises as it collects and stacks the vertical array of louvers. The upper channel assembly is typically pre-cut and pre-painted for color match.

The next section includes a series of louvers suspended in a rope ladder, each of the louvers having an aperture for accommodating the elevating lines between the upper channel member and a base louver. The base louver is supported by a combination of either or preferably both of the ladder verticals and ladder horizontals, as well as by the end of the elevating lines. The base louver may be covered by the last in a series of louvers to give a more finished look and appearance, especially where the base louver is made from a different material, or made from a material necessary to be bored or shaped to accommodate structure to hold or collect the string ladder. Where an additional top louver cover is provided, greater freedom can be had in limiting the necessity to finish the base louver only on its lateral outer and bottom sides.

Thickness or depth not usually being a problem, the two main dimensional adjustments are width and length. Width adjustment is difficult in that the width of the louvers, base louver, and upper rail must all be adjusted. When mounted outside a window opening on the inside of a room, the excess width or length can simply be left to extend beyond the window opening. When mounted within a window opening, a matching width is necessary to installation, but an improper length produces one of three conditions, either hanging outside the window opening at an inclined angle for an overly long set, or falling short of complete closure with a permanent gap, or if the blind set is mounted far enough inside the window, the base louver will simply cause a bottom number of slats to simply bunch together to cause an unsightly bunching of louvers and flattening together of louvers regardless of the position of the angle adjustment drums.

In being provided with an assembled louver set, the ability to customize vertically is limited and severely time consuming. First, adjustment on an assembled louver set can only be done by shortening. Where a short louver set is provided, it typically cannot be lengthened. Trying to add bits of ladder rope and lengths of vertical draw string is practically impossible. Even where the louver set is provided overly long, a worker must carefully untie or cut the vertical portions of the ladder string surrounding the angular positioning drums and then either remove the height adjustment cords through the channel from the top or remove the height adjustment cords from the bottom by disassembling the base louver. Unstringing the assembly will ideally be a slow exacting task where the assembly will be placed in a position to maintain order.

Not only is the provision of an overly long vertical blind set wasteful of time in disassembly, but the materials which are continually removed will tend to accumulate to no further use in the professional's shop. As a result, the cost of the overly long blind set will be higher priced. The elements of waste in this system include the wasted manpower at the factory assembling the overly long set, the wasted manpower at the installer's shop spent disassembling the overly long set, and finally the wasted materials from having manufactured a blind set having a length which is significantly longer than the average installation.

Further, the upper channel typically is provided in an array of more differentiated types of control. There are loop string controls for the angle adjustment drum as well as wand type controls. Where an installer uses equal amounts of each type, a given level of inventory will be doubled in order to stock both types. This doubling of inventory will be inventory of, for example, a set of fully complete wand units and a set of fully complete pull string units. Similarly, any other types of units will have their inventory numbers multiplied, not by a relatively inexpensive top channel alone, but by a fully made up blind assembly. Considering further differences, such as style and color, forces an even higher multiplier of inventory “waste” either in terms of inventory which may never be utilizable, or in foregone investment income which would otherwise be invested elsewhere.

What is needed is a method and structure which facilitates the provision of custom length vertical blinds in a manner which will enable a cut in the inventory level without compromising inventory availability, and which will reduce the cost of the produced structures. What is further needed is a facilitation of the ability for installers to easily form a custom vertical length blind set. Even more needed is a system which permits greater inventory balancing and statistically insures a reduction in inventory waste, conserving and pooling the parts for re-use, which would otherwise be lost to scrap. Needed also is a system which reduces the work time in providing a custom horizontal blind formation and installation.

### SUMMARY OF THE INVENTION

A modularized horizontal blind set provides a configuration which is easily modifiable, reduces inventory costs and waste. The only ultimate waste created from the modularized horizontal blind set is the trimming of ladder and elevation string or cord.

A completed bottom section, including base slat, a series of slats inserted into a ladder cord, and a set of elevation cords strung through the slats, with the ladder cord and elevation cords preferably properly tied off to enable a rapid layout and interconnect with a selected channel member. In forming a custom sized assembly, workers can utilize a chart based upon the vertical height of the top channel, and the spacing of the ladder chord. The ability to know in advance the number of louvers needed for a given height will first assure that an optimum length can be selected to insure that the base louver will always be able to extend to the lowest level within the window space, and second, enable a wide variety of different sized louver and ladder sets to be selected for a given size head rail. For example, where the window opening is five feet, and the number of louvers enabling a length just over five feet are addressable by chart indicating the exact number of louvers to include. This enables the worker to simply count the louvers above the base louver and its covering louver and remove excess louvers or add louvers to complete the count, and then assembling the horizontal blind set. Where the next application involves louvers which are narrower and which includes more louvers per unit of height, a chart may be again readily referred to enable the worker to count louvers rather than spend the time stretching the lower assembly, measuring it, and generating errors.

By eliminating the measurement step, significant time is saved. Further, since different ladder cord has different characteristics, such as time to relax, etc., the use of this technique eliminates the uncertainty of trying to stretch the ladder cord, and permits an installation which will settle into a more exacting height within 24-48 hours after installation. In other words, the characteristics of the materials can be taken to account in providing a chart for each type of material, each weight of material, each size of material and the like.

Further, in adjusting and in making up the slat and ladder rope portion of the modularized lower set by adjusting from the top, a more precise makeup can be had where the upper portion of the ladder cord is attached with the use of a spacer or similar automatic measuring technique. This is especially true where precision and consistency are required.

### BRIEF DESCRIPTION OF THE DRAWINGS

The invention, its configuration, construction, and operation will be best further described in the following detailed description, taken in conjunction with the accompanying drawings in which:

FIG. 1 is an elevated partially exploded perspective of the modularized horizontal blind set illustrating the extension of ladder cord and elevation cord into a “U” shaped channel and which shows an exploded view of the components to indicate how the cords are extended to construct the resulting custom blind set; and

FIG. 2 is a top view of the “U” shaped channel with components shown in place and the paths for the ladder and elevation cords shown.

### DETAILED DESCRIPTION OF THE PREFERRED EMBODIMENT

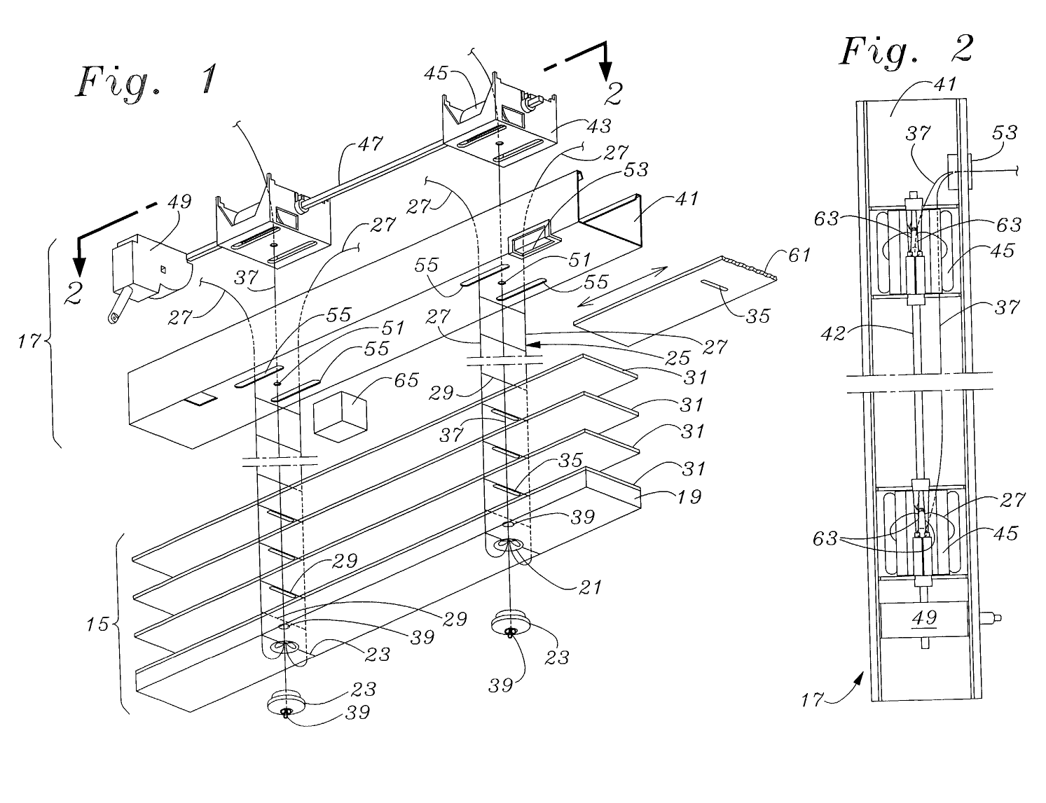

The description and operation of the invention will be best initiated with reference to FIG. 1 which illustrates from an elevated exploded view of a modularized horizontal blind set 11 having major sub component parts including a cord and louver assembly 15 and a channel and component assembly 17. The cord and louver assembly 15 will ideally be supplied in an assembled state with the free ends of the cord portions in an orderly collected manner.

A description of the cord and louver assembly 15 will be had beginning at the lower end. A base louver 19 has a relatively thicker extent, so as to accommodate a pair of bores 21 which may be fitted with an end plug 23. As can also be seen each side of the modularized horizontal blind set 11, a ladder cord 25 has a pair of vertical cord portions 27 and a plurality of connecting horizontal cord portions 29 evenly space along the vertical extent of the vertical cord portions 27. Ideally the excess length of vertical cord portions 27 will be tied into a bundle for shipping purposes as it is intended for cord and louver assembly 15 to be shipped, handled and inventoried as a separate item.

Above the base louver 19 a louver 31 is seen located atop the base louver 19 as may be desired to avoid having to finish the top of the base louver 19 and/or to enable finishing activities to be more sharply focussed on the sides and bottom of base louver 19. Other louvers 31 are seen distributed along the ladder cord 25 and may preferably be identical to louver 31. At the right side of the base louver 19, a technique is shown whereby the horizontal cord portion 29 below the base louver 19 is severed and the remaining ends of the vertical cord portions 27 are tucked within the bore 21. At the left side of the base louver 19, a technique is shown whereby the horizontal cord portion 29 below the base louver 19 remains and the traversing portion of the underlying horizontal cord portion 29 is inserted into the bore 21 and thus causing the next most vertically adjacent horizontal cord portion 29 to hug the top of the louver 31 most closely adjacent the base louver 19.

Each of the louvers 31 include an opening shown as an oblong slot 35 through which a vertical elevation cord 37 extends. The vertical elevation cord 37 extends through a relatively small aperture 39 at the top of the base louver 19 and extends through the bore 21. Ideally, the lower ends of the vertical elevation cords 37 may be secured by forming a knot 39 after the vertical elevation cords 37 pass through plug 23 in order that the suspension of the base louver 19 further act to keep the plug 23 in the bore 21. Ideally the excess length of the vertical elevation cords 37 will be tied into a bundle for shipping purposes as it is intended for cord and louver assembly 15 to be shipped, handled and inventoried as a separate item. Such tying, along with the tying of the vertical cord portions 27, will act to keep the cord and louver assembly 15 together as a neat bundle before such vertical elevation cords 37 and vertical cord portions 27 are untied to begin the sizing and assembly steps.

The vertical elevation cords 37 will eventually have free ends which can be joined and oriented without regard to the spacing and setting of the vertical length of the ladder cord 25. It is the setting of the vertical length of the ladder cord 25 with respect to an upper channel 41 of the channel and component assembly 17 which is of the most important. Also shown are support housings 43 for supporting rotation members 45 which may be linked by a rod 47. The rod 47 extends to a wand gear housing 49 which is one of two popular options with which the angles of the louvers 31 are adjusted.

At the bottom of the channel, a small aperture 51 is provided for enabling the vertical elevation cord 37 to enter the channel 41 and extend to an exit 53 in an orderly manner. A pair of spaced apart slots 55 are provided through which the vertical cord portions 27 operate. The openings are typically slots 55 to accommodate a horizontal louver tape suspension system so that the channel 41 may be used with a variety of horizontal blind systems where applicable. The vertical elevation cord 37 is seen adjacent the ladder cord 25, but this need not be the case.

In making up and assembling the modularized horizontal blind set 11, the cord and louver assembly 15 will typically be supplied with a given number of louvers 31. If additional louvers 31 are needed, a louver 61 can be added by simply slipping it into the ladder cord 25 between a pair of vertical cord portions 27 and a pair of horizontal cord portions 29, followed by re-stringing the vertical elevation cord 37 through the oblong slots 35 in the louver 61 which was just added.

In the alternative, if too many louvers 31 are present, the same louver 61 can be removed by pulling the ends of the vertical elevation cord 37 through the oblong slots 35 in the louver 61, and simply slipping it out of the ladder cord 25.

Referring to FIG. 2, a top view of the channel and component assembly 17 illustrates the support housings 43, rotation members 45, rod 47, and wand gear housing 49 in place. In the remaining description regarding how the modularized horizontal blind set 11 is assembled, both FIGS. 1 and 2 will be hereinafter referenced.

First, the overall length of the modularized horizontal blind set 11 is determined. A chart may be addressed to select the proper number of louvers 31 to be secured in a needed cord and louver assembly 15 once the size and type (and dimensions) of the channel 41 are selected in combination. For example, a lower profile channel 41 might require an additional louver 31 in the needed cord and louver assembly 15, than would a higher profile channel 41.

Once the proper number of louvers 31 are had, after addition or removal of louvers 61, the ends of the vertical elevation cord 37 are simply strung through the small apertures 51 of the channel 41 and underneath the support housings 43 on their way to the exit 53. The vertical elevation cord 37 can be left loose as its position is not critical to the overall length.

Next, the horizontal cord portions 29 above the topmost louver 31 are removed. The pair of vertical cord portions 27 above the uppermost louver are strung into the slots 55, and around and then above the rotation members 45. The ends of the vertical cord portions 27 are typically brought together over the rotation members 45 and together under specialized structures provided to completely and permanently fix the length of the pair of vertical cord portions 27 with respect to the rotation members 45, such as by securing into a tapered slot 63 or the like.

One suggestion to complete the steps is to use a spacer 65 for a given type of cord and louver assembly 15 to be placed between the uppermost louver 31 and the bottom of the channel 41, so that the pair of vertical cord portions 27 can be fitted onto the rotation members 45 as precisely as possible.

Exit 53 may have an interfitting pull cord lock, such as lock to enable a user to leave the elevation of the base louver 19 at a desired height.

While the present invention has been described in terms of a customizable horizontal blind assembly having been modularized at least to a cord and louver assembly which can be customizably integrated to a channel and component assembly, the principles contained therein are applicable to other types of window covering dimensional adjustment systems.

Although the invention is derived with reference to particular illustrative embodiments, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A cord and louver assembly comprising:
a pair of ladder cords, each ladder cord having a first and a second vertical cord portion each having a first and second end, said ladder cord including a plurality of spaced apart horizontal cord portions each having a first end connected to said first vertical cord portion and a second end connected to said second vertical cord portion, adjacent horizontal cord portions forming, with said first and second cord portion, a ladder opening;
a plurality of louvers, each louver within a ladder opening of each of said pair of ladder cords, each of said plurality of louvers having a first and a second elevation cord opening;
a base louver having a first and a second bore, each of said first and said second bores for accommodating an end plug;
a first end plug, having an aperture, for fitting within said bore of said base louver;
a second end plug, having an aperture, for fitting within said second bore of said base louver;
a first vertical elevation cord, having a first end and a second end, and extending through each said first elevation cord openings of said plurality of louvers, and said aperture of said first end plug and affixed adjacent said first end of said first vertical elevation cord to secure said first vertical elevation cord first end from pulling free of said first end plug;
a second vertical elevation cord, having a first end and a second end, and extending through each said second elevation cord openings of said plurality of louvers, and said aperture of said second end plug and affixed adjacent said first end of said second vertical elevation cord to secure said second vertical elevation cord first end from pulling free of said second end plug, said first and said second end plugs also for securing said first ends of said first and said second ladder cords.

2. The cord and louver assembly as recited in claim 1 and wherein said first and said second vertical elevation cords are bundled together adjacent their respective second ends to secure said cord and louver assembly as a unit.

3. The cord and louver assembly as recited in claim 1 and wherein said ladder cords are bundled together adjacent their respective second ends to secure said cord and louver assembly as a unit.

4. The cord and louver assembly as recited in claim 1 and further comprising a channel and component assembly to which said cord and louver assembly is attached to form a horizontal blind set.

5. A process of forming a horizontal blind set comprising the steps of:
in a cord and louver assembly having:
a pair of ladder cords, each ladder cord having a first and a second vertical cord portion each having a first and second end, said ladder cord including a plurality of spaced apart horizontal cord portions each having a first end connected to said first vertical cord portion and a second end connected to said second vertical cord portion, adjacent horizontal cord portions forming, with said first and second cord portion, a ladder opening;
a plurality of louvers, each louver within a ladder opening of each of said pair of ladder cords, each of said plurality of louvers having a first and a second elevation cord opening;
a base louver having a first and a second bore, each of said first and said second bores for accommodating an end plug;
a first end plug, having an aperture, for fitting within said bore of said base louver;
a second end plug, having an aperture, for fitting within said second bore of said base louver;
a first vertical elevation cord, having a first end and a second end, and extending through each said first elevation cord openings of said plurality of louvers, and said aperture of said first end plug and affixed adjacent said first end of said first vertical elevation cord to secure said first vertical elevation cord first end from pulling free of said first end plug;
a second vertical elevation cord, having a first end and a second end, and extending through each said second elevation cord openings of said plurality of louvers, and said aperture of said second end plug and affixed adjacent said first end of said second vertical elevation cord to secure said second vertical elevation cord first end from pulling free of said second end plug, said first and said second end plugs also for securing said first ends of said first and said second ladder cords;
extending said second ends of said first and said second vertical elevation cords through respective first and second small apertures in the base of a channel and component assembly for exiting said channel and component assembly at a location to enable users to pull said first and said second vertical elevation cords to raise and lower said base louver;
extending said second ends of said first and a second vertical cord portions of said a pair of ladder cords through respective openings in said channel and component assembly;
attaching said second ends of said first and a second vertical cord portions of said a pair of ladder cords each to a respective rotation member of said channel and component assembly, to form said horizontal blind set.

6. The process of forming a horizontal blind set as recited in claim 5 and further comprising the step of at least one of removing and adding a louver to and from, respectively said opening of each of said pair of ladder cords, to thereby perform the action of at least one of adding to and subtracting from the number of said plurality louvers to provide a more custom height adjustment.

7. The process of forming a horizontal blind set as recited in claim 5 and further comprising the step of unbundling said first and said second vertical elevation cords adjacent their respective second ends to dissemble said cord and louver assembly from its unitary status.

8. The process of forming a horizontal blind set as recited in claim 5 and further comprising the step of unbundling said ladder cords adjacent the respective second ends of their first and a second vertical cord portions to dissemble said cord and louver assembly from its unitary status.
